(19) United States
(12) Patent Application Publication
(10) Pub. No.: US 2004/0155534 A1
(43) Pub. Date: Aug. 12, 2004

(54) Structure integrating gas support bearing and a planar electromagnetic drive and levitation system

(76) Inventor: Mats Anders Engwall, San Juan Bautista, CA (US)

Correspondence Address: The Law Office of Steven G. Roeder, 5560 Chelsea Avenue, La Jolla, CA, 92037, US

(21) Appl. No.: 10/360,985

(22) Filed: Feb. 7, 2003

(51) Int. Cl. H02K 41/00

(52) U.S. Cl. 310/12

(57) ABSTRACT

A combination (231) that creates a fluid film bearing that maintains a stage frame (202) spaced apart from a base frame (204), includes a pad assembly (232) secured to one of the frames (202)(204) and a bearing fluid source (234). The pad assembly (232) includes a porous region (238). The fluid source (234) directs a fluid into the pad assembly (232) so that the fluid is released from the porous region (238) to create the fluid film bearing that maintains the stage frame (202) apart from the base frame (204). The combination (231) is used with a mover (206) having a conductor assembly (218) that is secured to one of the frames (202)(204) and a magnet assembly (216) that is secured to the other one of the frames (202)(204).

### FIELD OF THE INVENTION

The present invention relates generally to electric motors for use with a lithographic device for the fabrication of integrated circuits on semiconductor wafers.

### BACKGROUND

Linear and planar electric motors are used in a variety of devices and systems. For example, linear and planar electric motors are used to precisely position a semiconductor wafer during photolithography and other semiconductor processes. The accurate positioning of the wafer during processing is critical to creating high-density semiconductor wafers. Also, linear or planar motors are used in other devices, including elevators, electric razors, machine tools, and inspection tools.

A linear electric motor can include a magnet assembly and a coil assembly positioned adjacent to the magnet assembly. The assemblies are arranged in a line to permit relative motion in one direction only. This arrangement is referred to as a one-dimensional motor. A planar electric motor generally has a two-dimensional magnet assembly and a two-dimensional coil assembly positioned adjacent to the magnet assembly. Electric currents in the coil assembly give rise to a force between the coil assembly and the magnet assembly that can be used to move one of the assemblies relative to the other assembly.

The magnet assembly can be maintained apart from the coil assembly in a number of ways, including a fluid film type bearing, a rolling type bearing, a magnetic levitation type bearing or another type of guide. For example, if a fluid film type bearing is used, typically, a fluid source releases pressurized fluid from a plurality of conduits positioned between the magnet assembly and the coil assembly. The pressurized fluid maintains the assemblies spaced apart. In this example, the fluid is normally a gas, but can, alternatively, be a liquid.

Unfortunately, adequate space is necessary to position the plurality of conduits and direct the fluid between the magnet assembly and the coil assembly. As a result thereof, the coil assembly must be spaced apart from the magnet assembly a sufficient distance to allow space for the plurality of conduits. In most cases, the larger the spacing between the assemblies, the larger the reduction in the efficiency of the motor, and the larger the required size of the motor.

In light of the above, there is a need for a combination and an integration scheme that allows for the positioning of the coil assembly relatively close to magnet assembly. Additionally, there is a need for a compact and efficient motor for a precision device. Moreover, there is a need for an exposure apparatus capable of manufacturing precision devices.

### SUMMARY

A combination that creates a fluid bearing that maintains a stage frame spaced apart from a body frame, includes a pad assembly secured to one of the frames and a fluid source. The pad assembly includes a porous region. The fluid source directs a fluid into the pad assembly so that the fluid is released from the porous region to create the fluid bearing that maintains the stage frame apart from the body frame.

In one embodiment, the combination is used as part of a mover assembly having a conductor assembly that is secured to one of the frames and a magnet assembly that is secured to the other frame. The conductor assembly includes a plurality of conductors and the magnet assembly includes a plurality of magnets. With this design, the fluid bearing is structurally integrated into the mover assembly and the combination allows for the positioning of the conductors relatively close to the magnets while releasing fluid between the frames to support the frames spaced apart. As a result thereof, the mover assembly can be made more compact and the propulsion forces generated by the mover assembly are enhanced.

The pad assembly can be positioned directly between the magnet assembly and the conductor assembly. The porous region can have pores the size of approximately 1 micron to approximately 300 microns. Further, the pad assembly can include a plurality of spaced apart porous regions.

In one embodiment, the pad assembly includes a fluid channel that is in fluid communication with the fluid source and the porous region. Further, the fluid channel includes a first pad passageway and a plurality of second pad passageways that branch away from the first pad passageway. A cross-sectional area of the first pad passageway is larger than a cross-sectional area of one of the second pad passageways.

The base frame can include a frame passageway that is in fluid communication with the fluid source and the pad assembly. Further, the base frame can include a vacuum passageway that is fluid communication with a vacuum source to create a vacuum near the fluid film bearing.

Additionally, the present invention is directed to a mover assembly, a stage assembly, an exposure apparatus, a method for making an exposure apparatus that forms an image from a first object onto a second object, and a method for making a device utilizing the exposure apparatus.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a side illustration of an exposure apparatus having features of the present invention;

FIG. 2 is a perspective view of a stage assembly having features of the present invention;

FIG. 3A is an exploded perspective view of a stage frame and a magnet assembly having features of the present invention;

FIG. 3B is an exploded perspective view of a base frame, a conductor assembly and a pad assembly having features of the present invention;

FIG. 4 is an enlarged cut-away view taken on line 4-4 of FIG. 2;

FIG. 5A is a perspective view of a bearing pad having features of the present invention;

FIG. 5B is an alternate perspective view of the bearing pad of FIG. 5A;

FIG. 5C is a cut-away view taken on line 5C-5C in FIG. 5A;

FIG. 5D is an exploded perspective view of the bearing pad of FIG. 5A;

FIG. 6 is a cut-away view of another embodiment of a bearing pad having features of the present invention;

FIG. 7A is a perspective view of a mover pad having features of the present invention;

FIG. 7B is a perspective view of an alternate embodiment of the mover pad;

FIG. 8 is a perspective view of another embodiment of a stage assembly having features of the present invention;

FIG. 9A is a flow chart that outlines a process for manufacturing a device in accordance with the present invention; and

FIG. 9B is a flow chart that outlines device processing in more detail.

### DESCRIPTION

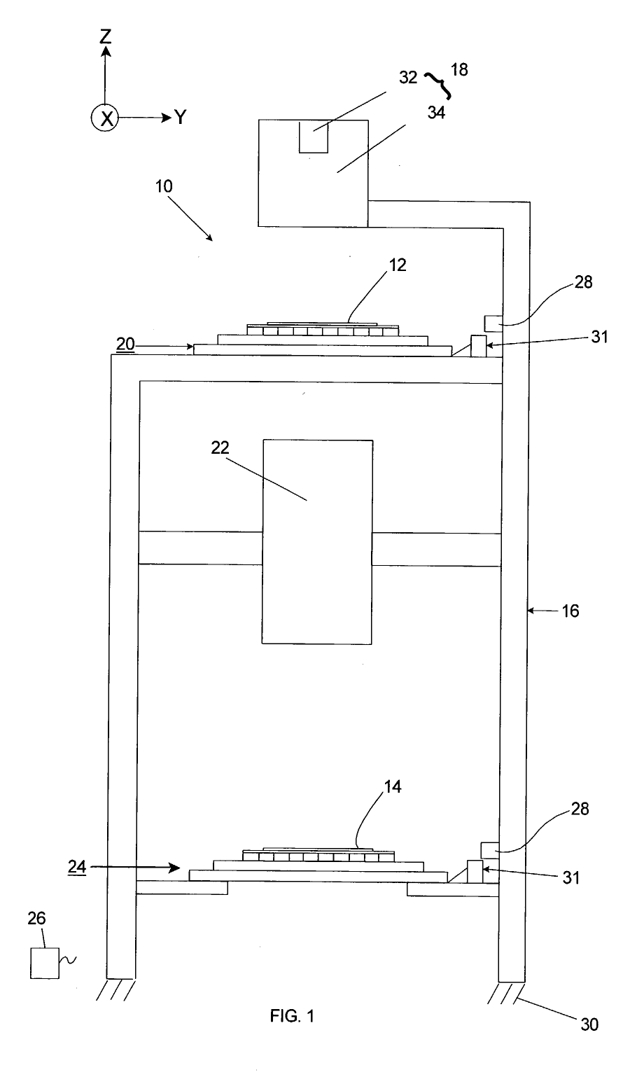

The present invention relates to a device and method for creating a fluid film bearing in a precision assembly. FIG. 1 is a schematic side view that illustrates a precision assembly, namely an exposure apparatus 10. The exposure apparatus 10 is particularly useful as a lithographic device that transfers a pattern (not shown) for an integrated circuit from a reticle 12 onto a semiconductor wafer 14. In FIG. 1, the exposure apparatus 10 includes an apparatus frame 16, an illumination system 18 (irradiation apparatus), a reticle stage assembly 20, an optical assembly 22 (lens assembly), a wafer stage assembly 24, a control system 26, and a measurement system 28. The exposure apparatus 10 mounts to a mounting base 30, e.g., the ground, a base, or floor or some other supporting structure. The design of the components of the exposure apparatus 10 can be varied to suit the design requirements of the exposure apparatus 10.

As an overview, the reticle stage assembly 20 and the wafer stage assembly 24 each can include a combination 31 that creates a fluid film bearing that allows each stage assembly 20, 24 to function more efficiently. This improves the positioning performances of the stage assemblies 20, 24 and allows for more accurate positioning of the semiconductor wafer 14 relative to the reticle 12.

It should be noted that the combination 31 can be used to create a fluid film bearing to support other components of the exposure apparatus 10. Still alternatively, the fluid film bearing provided herein can be used in other precision assemblies, including other semiconductor processing equipment, machine tools, metal cutting machines, and inspection machines.

A number of Figures include an orientation system that illustrates an X axis, a Y axis that is orthogonal to the X axis and a Z axis that is orthogonal to both X and Y axes. It should be noted that these axes can also be referred to as the first, second and third axes.

There are a number of different types of lithographic devices. For example, the exposure apparatus 10 can be used as scanning type photolithography system that exposes the pattern from the reticle 12 onto the wafer 14 with the reticle 12 and the wafer 14 moving synchronously. In a scanning type lithographic device, the reticle 12 is moved perpendicular to an optical axis of the optical assembly 22 by the reticle stage assembly 20 and the wafer 14 is moved perpendicular to the optical axis of the optical assembly 22 by the wafer stage assembly 24. Scanning of the reticle 12 and the wafer 14 occurs while the reticle 12 and the wafer 14 are moving synchronously.

Alternatively, the exposure apparatus 10 can be a step-and-repeat type photolithography system that exposes the reticle 12 while the reticle 12 and the wafer 14 are stationary. In the step and repeat process, the wafer 14 is in a fixed position relative to the reticle 12 and the optical assembly 22 during the exposure of an individual field. Subsequently, between consecutive exposure steps, the wafer 14 is consecutively moved with the wafer stage assembly 24 perpendicularly to the optical axis of the optical assembly 22 so that the next field of the wafer 14 is brought into position relative to the optical assembly 22 and the reticle 12 for exposure. Following this process, the images on the reticle 12 are sequentially exposed onto the fields of the wafer 14 so that the next field of the wafer 14 is brought into position relative to the optical assembly 22 and the reticle 12.

However, the use of the exposure apparatus 10 provided herein is not limited to a photolithography system for semiconductor manufacturing. The exposure apparatus 10, for example, can be used as a liquid crystal display photolithography system that exposes a liquid crystal display device pattern onto a rectangular glass plate or a photolithography system for manufacturing a thin film magnetic head. Further, the present invention can also be applied to a proximity photolithography system that exposes a mask pattern from a mask onto a substrate with the mask located close to the substrate, without the use of a lens assembly.

The apparatus frame 16 is rigid and supports the components of the exposure apparatus 10. The apparatus frame 16 illustrated in FIG. 1 supports the optical assembly 22, the illumination system 18, and the stage assemblies 20, 24 above the mounting base 30.

The illumination system 18 includes an illumination source 32 and an illumination optical assembly 34. The illumination source 32 emits a beam (irradiation) of light energy. The illumination optical assembly 34 guides the beam of light energy from the illumination source 32 to the reticle 12. The beam selectively illuminates different portions of the reticle 12 and exposes the semiconductor wafer 14. In FIG. 1, the illumination source 32 is illustrated as being supported above the reticle stage assembly 20. Typically, however, the illumination source 32 is secured to one of the sides of the apparatus frame 16 and the energy beam from the illumination source 32 is directed to the reticle 12 with the illumination optical assembly 34.

The illumination source 32 can be a g-line source having a wavelength of approximately 436 nm, an i-line source having a wavelength of approximately 365 nm, a KrF excimer laser having a wavelength of approximately 248 nm, an ArF excimer laser having a wavelength of approximately 193 nm or a F₂ laser having a wavelength of approximately 157 nm. Alternatively, the illumination source 32 can use charged particle beams such as an x-ray or an electron beam. For instance, in the case where an electron beam is used, thermionic emission type lanthanum hexaboride (LaB₆) or tantalum (Ta) can be used as cathodes in an electron gun. Furthermore, in the case where an electron beam is used, the structure could be such that either a mask is used or a pattern can be directly formed on a substrate without the use of a mask.

The optical assembly 22 projects and/or focuses the light passing through the reticle 12 to the wafer 14. Depending upon the design of the exposure apparatus 10, the optical assembly 22 can magnify or reduce the image illuminated on the reticle 12. The optical assembly 22 need not be limited to a reduction system. It could also be a 1× or magnification system.

When the illumination source 32 is an excimer laser that produces ultra-violet rays, glass materials such as quartz and fluorite that transmit far ultra-violet rays can be used in the optical assembly 22. Alternatively, when the illumination source 32 is a F₂ type laser or x-ray device, the optical assembly 22 can be either catadioptric or refractive (a reticle should also preferably be a reflective type), and when the illumination source 32 produces an electron beam, electron optics consisting of electron lenses and deflectors can be utilized in the optical assembly 22. The optical path for the electron beams should be traced in vacuum.

Also, with an exposure device that employs vacuum ultra-violet radiation (VUV) of wavelength 200 nm or shorter, use of the catadioptric type optical system can be considered. Examples of the catadioptric type of optical system include the disclosure Japan Patent Application Disclosure No.8-171054 published in the Official Gazette for Laid-Open Patent Applications and its counterpart U.S. Pat. No. 5,668,672, as well as Japan Patent Application Disclosure No.10-20195 and its counterpart U.S. Pat. No. 5,835,275. In these cases, the reflecting optical device can be a catadioptric optical system incorporating a beam splitter and concave mirror. Japan Patent Application Disclosure No.8-334695 published in the Official Gazette for Laid-Open Patent Applications and its counterpart U.S. Pat. No. 5,689,377 as well as Japan Patent Application Disclosure No.10-3039 and its counterpart U.S. patent application Ser. No. 873,605 (Application Date: Jun. 12, 1997) also use a reflecting-refracting type of optical system incorporating a concave mirror, etc., but without a beam splitter, and can also be employed with this invention. As far as is permitted, the disclosures in the above-mentioned U.S. patents, as well as the Japan patent applications published in the Official Gazette for Laid-Open Patent Applications are incorporated herein by reference.

The reticle stage assembly 20 holds and positions the reticle 12 relative to the optical assembly 22 and the wafer 14. Somewhat similarly, the wafer stage assembly 24 holds and positions the wafer 14 with respect to the projected image of the illuminated portions of the reticle 12.

Forces producing the necessary movement of the stages generate reaction forces that can affect performance of the photolithography system. Reaction forces generated by the wafer (substrate) stage motive force can be mechanically transferred to the floor (ground) by use of a frame member as described in U.S Pat. No. 5,528,100 and published Japanese Patent Application Disclosure No. 8-136475. Additionally, reaction forces generated by the reticle (mask) stage motive forces can be mechanically transferred to the floor (ground) by use of a frame member as described in U.S. Pat. No. 5,874,820 and published Japanese Patent Application Disclosure No. 8-330224. As far as is permitted, the disclosures in U.S. Pat. Nos. 5,528,100 and 5,874,820 and Japanese Patent Application Disclosure No. 8-330224 are incorporated herein by reference.

The control system 26 is connected to the measurement system 28 and a driving device (not shown) like a motor that controls positions of the reticle stage assembly 20 and the wafer stage assembly 24.

The measurement system 28 monitors movement of the reticle 12 and the wafer 14 relative to the optical assembly 22 or some other reference. With this information, the control system 26 can control the reticle stage assembly 20 to precisely position the reticle 12 and the wafer stage assembly 24 to precisely position the wafer 14. For example, the measurement system 28 can utilize multiple laser interferometers, encoders, and/or other measuring devices.

A photolithography system (an exposure apparatus) according to the embodiments described herein can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a comprehensive adjustment is performed to make sure that accuracy is maintained in the complete photolithography system. Additionally, it is desirable to manufacture an exposure system in a clean room where the temperature and cleanliness are controlled.

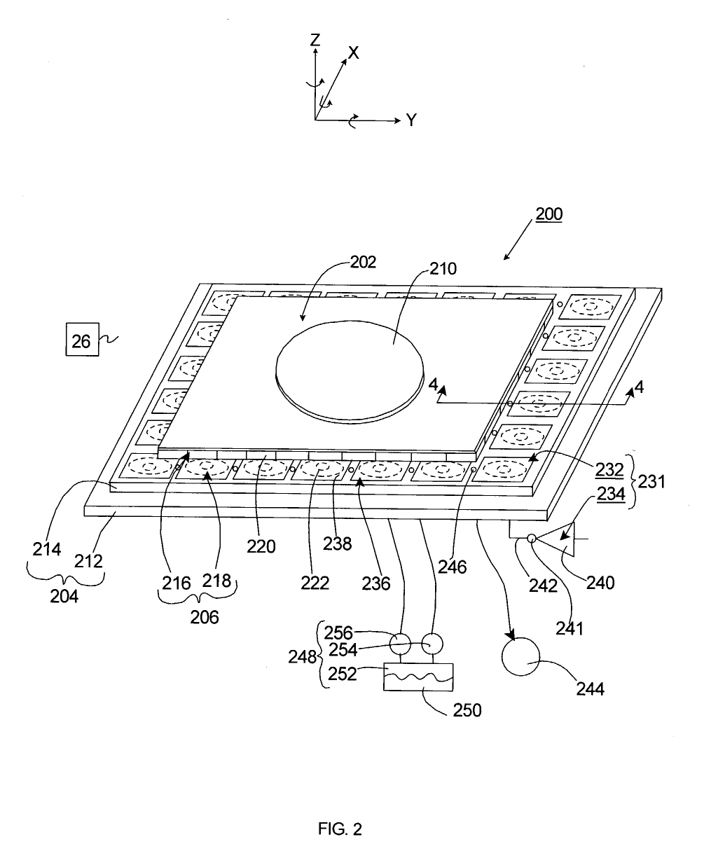

FIG. 2 is a perspective view of a stage assembly 200 that can be used in the exposure apparatus 10 (illustrated in FIG. 1). In FIG. 2, the stage assembly 200 includes a stage frame 202, a base frame 204, a mover 206, and a combination 231 that creates a fluid bearing that allows for movement of the stage frame 202 relative to the base frame 204. Further, in this embodiment, the fluid bearing is structurally integrated into the mover 206. The stage assembly 200 can be used for precisely positioning a device 210 such as the wafer, or another type of device or object during a manufacturing and/or an inspection process. For example, the concepts provided herein can be incorporated into a wafer stage assembly or a reticle stage assembly. The components of the stage assembly 200 can be varied to suit the design requirements of the stage assembly 200.

The stage frame 202 retains the device 210. In FIG. 2, the stage frame 202 is generally rectangular plate shaped and includes a device holder such as a vacuum chuck, an electrostatic chuck, or some other type of clamping device that retains the device 210 to the top of the stage frame 202. Alternatively, the stage frame 202 can be another shape and/or include multiple device holders for retaining multiple devices simultaneously. The stage frame 202 also supports a portion of the mover 206. For example, the stage frame 202 can be made of a low or non-electrically conductive, non-magnetic material, such as low electrical conductivity stainless steel or titanium, or non-electrically conductive plastic or ceramic.

The base frame 204 cooperates with the combination 231 to support the stage frame 202. In FIG. 2, the base frame 204 is generally rectangular plate shaped, and includes a base section 212, and a support section 214 that supports a portion of the combination 231 and a portion of the mover 206. For example, the base frame 204 can be made of a low or non-electrically conductive, non-magnetic material, such as low electrical conductivity stainless steel or titanium, or non-electrically conductive plastic or ceramic.

The mover 206 precisely moves and positions the stage frame 202 and the device 210 relative to the base frame 204. The design of the mover 206 can vary. For example, the mover 206 can move the stage frame 202 with six degrees of freedom, three degrees of freedom, or one degree of freedom. In FIG. 2, the mover 206 moves the stage frame 202 with three degrees of freedom, namely, along the X axis, along the Y axis and about the Z axis. In this embodiment, the mover 206 is a planar electric motor and includes a magnet assembly 216 and a conductor assembly 218 (illustrated in phantom). One of the assemblies 216, 218 is secured to the base frame 204 and the other assembly 218, 216 is secured to the stage frame 202. In FIG. 2, the magnet assembly 216 is secured to the bottom of the stage frame 202 and the conductor assembly 218 is secured to the base frame 204. Alternatively, the magnet assembly 216 can be secured to the base frame 204 and the conductor assembly 218 can be secured to the stage frame 202.

In this embodiment, the magnet assembly 216 includes a plurality of magnets 220 that are secured to the bottom of the stage frame 202 and the conductor assembly 218 includes a plurality of spaced apart, conductors 222 (illustrated in phantom) that are secured to the base frame 204. For example, each magnet 220 can be rectangular shaped and can be made of NdBFe and each conductor 222 can be a flat, rectangular tube shaped coil that is made of conventional insulated wire bonded together in an epoxy.

The size and shape of the conductor assembly 218 and the magnet assembly 216 and the spacing and positioning of the conductors 222 and the magnets 220 can be varied to suit the design requirements of the stage assembly 200. For example, in FIG. 2, the conductor assembly 218 includes fourty-two conductors 222 that are arranged seven conductors 222 wide by six conductors 222 deep and the magnet assembly 216 includes sixty magnets 220 that are positioned side-by-side and arranged ten magnets 220 wide by six magnets 220 deep. In this embodiment, the magnet assembly 216 is sized so that an equivalent of approximately twenty conductors 222, five wide by four deep, are within the magnetic field of the magnet assembly 216. Thus, when the magnet assembly 216 is positioned near the conductor assembly 218, an equivalent of approximately twenty conductors 222 can interact with the magnetic field of the magnet assembly 216.

Electrical current through the conductors 222 causes the conductors 222 to interact with the magnetic field of the magnet assembly 216. This generates a Lorentz type force between the magnet assembly 216 and conductor assembly 218 that can be used to control, move, and position one of the assemblies 216, 218 relative to the other one of the assemblies 218, 216. For example, the electrical current through the conductors 222 can cause levitation forces (along Z axis) between the conductor assembly 218 and the magnetic assembly 216, as well as in-plane forces between the conductor assembly 218 and the magnetic assembly 216 (along the X axis and the Y axis).

For the embodiments in which the magnet assembly 216 moves relative to the conductor assembly 218, the conductors 222 can be individually controlled and switched electrically or electronically with the control system 26 so that only conductors 222 wholly and/or partially covered by the magnet assembly 216 are energized. In other words, only conductors 222 that are in a position to interact with the magnetic field of the magnet assembly 216 are energized. The current level for each conductor 222 is controlled and adjusted by the control system 26 to achieve the desired resultant forces. Not applying current to the conductors 222 outside of the magnetic field of the magnet assembly 216 minimizes heat created by the conductor assembly 218.

It should be noted that, the mover 206 can include additional actuators and/or motors for moving the device 210. For example, one or more motors could be used to move the device 210 relative to the stage frame 202.

The combination 231 creates a fluid film bearing between the stage frame 202 and the base frame 204 to support the stage frame 202 away from the base frame 204 and allow for movement of the stage frame 202 relative to the base frame 204. The present invention allows the assemblies 216, 218 of the mover 206 to be placed in close relative positions. Moreover, the combination 231 provides improved support of the stage frame 202. As a result thereof, the mover 206 is more efficient and propulsion forces generated by the mover 206 can be increased. Further, the overall size of the stage assembly 200 can be reduced.

The design of the components of the combination 231 can be varied to suit the design requirements of the stage assembly 200. In the embodiment illustrated in FIG. 2, the combination 231 includes a pad assembly 232 and a bearing fluid source 234.

The pad assembly 232 is secured to one of the frames 202, 204 and can include a plurality of spaced bearing pads 236. In FIG. 2, the pad assembly 232 includes forty-two spaced apart bearing pads 236 that are secured to the base frame 204. Alternatively, however, the pad assembly 232 can include more than forty-two bearing pads 236, less than forty-two bearing pads 236 and/or the bearing pads 236 can be secured instead to the stage frame 202.

The bearing pads 236 release the fluid from the bearing fluid source 234 to create the fluid film bearing between the adjacent frames 202, 204. In FIG. 2, each bearing pad 236 is positioned directly above one of the conductors 222 and is positioned directly between the magnet assembly 216 and the conductor assembly 218. Further, each bearing pad 236 includes a porous region 238 having a plurality of spaced apart pores so that the fluid from the bearing fluid source 234 can be released between the adjacent frames 202, 204.

The bearing fluid source 234 directs a pressurized fluid into the bearing pads 236 so that the fluid is released from the porous regions 238 to create the fluid film bearing between the base frame 204 and the stage frame 202. The design of the bearing fluid source 234 can be varied to suit the requirements of the fluid film bearing. For example, one or more bearing fluid sources 234 can be used to force or direct the fluid through the bearing pads 236 to create the fluid film bearing. In FIG. 2, a single bearing fluid source 234 is used to direct fluid to the plurality of pads 236. The bearing fluid source 234 illustrated in FIG. 2 includes a fluid pump 240, a flow regulator 241 and an outlet conduit 242 that connects the fluid pump 240 in fluid communication with the base frame 204.

The flow rate, pressure and type of the fluid from the bearing fluid source 234 is selected and controlled to precisely control the amount of the fluid film gap between the stage frame 202 and the stage base 204 and the stiffness of the fluid film bearing. For the embodiments illustrated, the fluid film gap is typically maintained between approximately one micron and ten microns. However, the fluid film gap can be less than one micron or more than ten microns. The fluid from the bearing fluid source 234 can, for example, be air or some other gas, or gas mixture. When air is utilized, an “air bearing” is created.

In FIG. 2, the bottom surface of the magnet assembly 216 and the top surface of the base frame 204 each can have a relatively fine surface finish, e.g. a surface roughness of less than approximately 0.2 microns. This allows for a relatively small fluid gap between the magnet assembly 216 and the base frame 204 without contact between the magnet assembly 216 and the base frame 204.

To increase stiffness, the fluid film bearing can be a pre-loaded. In FIG. 2, the stage assembly 200 includes a vacuum source 244, e.g. a vacuum pump, and the base frame 204 includes a plurality of spaced apart vacuum apertures 246 that are in fluid communication with the vacuum source 244. With this design, the vacuum source 244 pulls a vacuum at the vacuum apertures 246 to preload the fluid film bearing. Alternatively, the fluid film bearing can be preloaded in another fashion.

Additionally, the stage assembly 200 can include a circulating system 248 for circulating a fluid 250 around or near the conductor assembly 218 to cool one or more of the conductors 222. The design of the circulating system 248 can be varied to suit the cooling requirements of the conductors 222. For example, the circulating system 222 can direct the circulating fluid 250 around each of the conductors 222 and can include a reservoir 252 for receiving the circulating fluid 250, a heat exchanger 254, i.e. a chiller unit, for cooling the fluid 250, and a fluid pump 256. The temperature, fluid pressure, flow rate, and type of the fluid 250 is selected and controlled to precisely control the temperature of the one or more of the conductors 222.

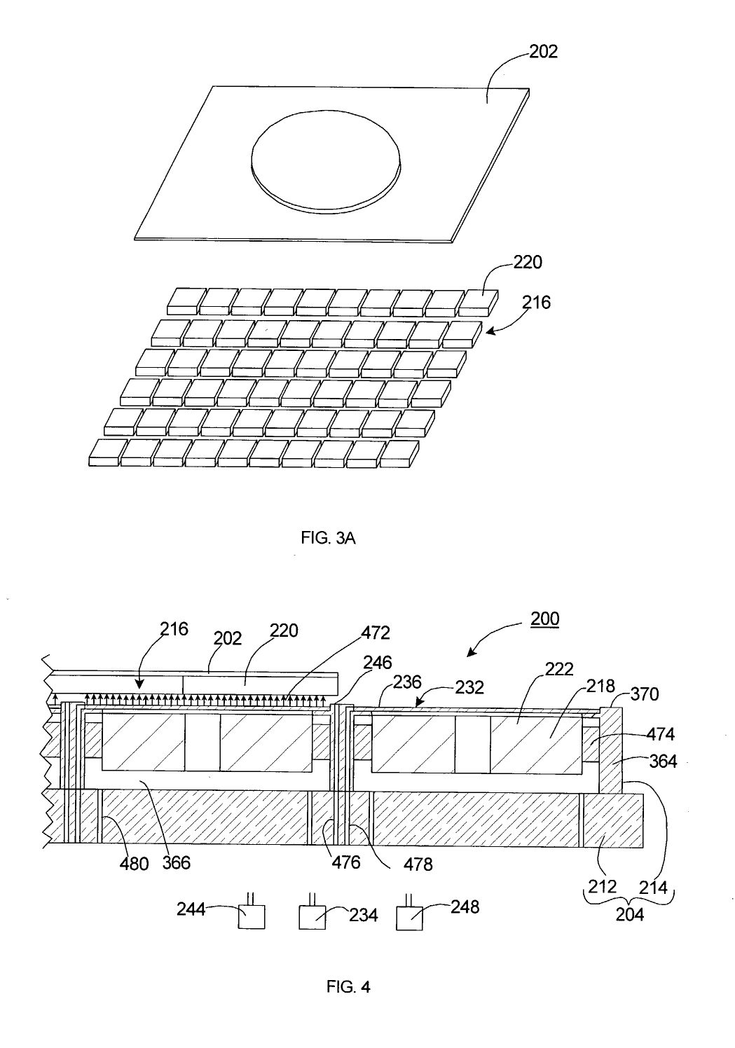

FIG. 3A illustrates an exploded perspective view of the stage frame 202 and the magnets 220 of the magnet assembly 216. In this embodiment, the stage frame 202 is generally rectangular flat plate shaped and each of the magnets 220 is generally rectangular shaped. Alternatively, one or more of the magnets 220 can have another shape. The magnets 220 can be secured to the stage frame 202 in a number of ways, including an adhesive, or by potting.

FIG. 3B illustrates an exploded perspective view of the base frame 204, the conductor assembly 218 including the conductors 222 and the pad assembly 232 including the bearing pads 236. The base frame 204 includes the base section 212 and the support section 214. The base section 212 is generally planar shaped and supports the support section 214. The support section 214 is rectangular lattice shaped and includes a rectangular shaped outer frame 360, a plurality of spaced, generally parallel first walls 362 and a plurality of spaced apart, generally parallel second walls 364. The first walls 362 are crisscrossed with the second walls 364 between the outer frame 360 to define a plurality of spaced apart conductor cavities 366 for receiving the conductors 222 and the bearing pads 236. In FIG. 3B, the first walls 362 are perpendicular to the second walls 364. Alternatively, the angle of the first walls 362 relative to the second walls 364 can be different than ninety degrees.

The shape and number of conductor cavities 366 can be varied. In FIG. 3B, each conductor cavity 366 is generally rectangular box shaped and is sized and shaped to receive one of the conductors 222. Further, the support section 214 includes forty-two spaced apart conductor cavities 366 that are arranged seven conductor cavities 366 wide by six conductor cavities 366 deep. Alternatively, other shapes and configurations are possible. In one embodiment, the conductor cavities 366 are sized and shaped to provide a fluid passageway around the conductors 222. With this design, the temperature of each conductor 222 can be individually monitored and controlled by controlling the flow of the circulating fluid 250 (illustrated in FIG. 2) into the conductor cavities 366.

In the embodiment illustrated in FIG. 3B, the walls 362, 364 cooperate to define a plurality of pad supports 368 that support the bearing pads 236. In FIG. 3B, each pad support 368 is rectangular shaped lip that supports one bearing pad 236 below an upper surface 370 of the support section 214. Alternatively, the pad support 368 could be another type of support.

In FIG. 3B, the upper surface 370 of the support section 214 is positioned above the bearing pads 236. With this design, the upper surface 370 engages the magnet assembly 216 (illustrated in FIG. 2) and inhibits the magnet assembly 216 from contacting and damaging the bearing pads 236 when the fluid film bearing is turned off. The unwanted contact could also plug exposed pores of the bearing pads 236. The upper surface 370 can be created by machining, plating or sputtering, for example.

In FIG. 3B, each bearing pad 236 is generally rectangular plate shaped. Alternatively, other configurations of the bearing pad 236 can be utilized. For example, one or more of the bearing pads 236 could have an octagonal shape, a circular shape, and/or a triangular shape.

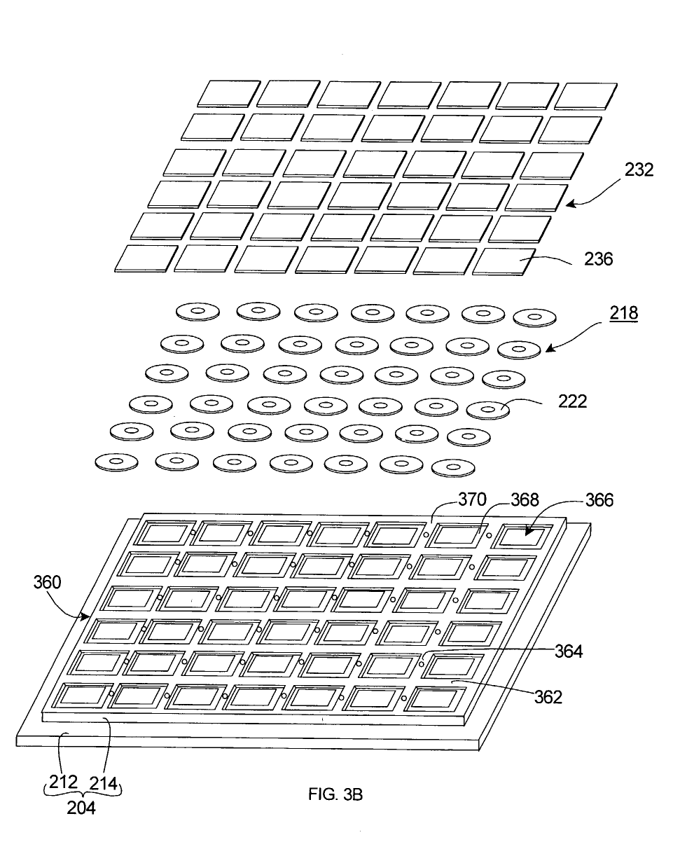

FIG. 4 is a cross-sectional view of a portion of the stage assembly 200 taken from FIG. 2 that illustrates the stage frame 202 and magnets 220 of the magnet assembly 216 positioned above the base frame 204, the conductors 222 of the conductor assembly 218, and the bearing pads 236 of the pad assembly 232. FIG. 4 illustrates that the bearing pads 236 allow the conductors 222 to be placed in relatively close proximity to the magnets 220 while providing for a substantially uniform fluid film bearing 472 (illustrated as arrows) there between. This allows the stage assembly 200 to operate more efficiently.

The conductors 222 can be secured to the base frame 204 in a number of ways. For example, FIG. 4 illustrates that for each conductor 222, a pair of conductor supports 474 extend between the outer perimeter of each conductor 222 and the second walls 364 to rigidly secure each of the conductors 222 to the support section 214. Alternatively, for example, each conductor 222 could be secured with an adhesive directly to the one bearing pad 236 or the top of the base section 212.

Additionally, the base frame 204 includes a plurality of vacuum passageways 476 and a plurality of bearing passageways 478 that extend through the base section 212 and the second walls 364. The vacuum passageways 476 connect the vacuum source 244 in fluid communication with the vacuum apertures 246. The bearing passageways 478 connect the bearing fluid source 234 in fluid communication with the bearing pads 236. With this design, fluid from the bearing fluid source 234 is released from the bearing pads 236 towards the magnet assembly 216 to create the fluid film bearing 472 that lifts, levitates, and supports the magnet assembly 216. At the same time, the vacuum source 244 pulls a vacuum in the vacuum apertures 246 to preload the fluid film bearing 472.

Moreover, the base frame 204 includes a plurality of circulation passageways 480 that extend through the base section 212 into the conductor cavities 366. The circulation passageways 480 connect the circulating system 248 in fluid communication with the conductor cavities 366.

The location and design of the passageways 476, 478, 480 can be varied. In FIG. 4, the vacuum passageways 476 and bearing passageways 478 are each channels that are positioned adjacent to each other in the second walls 364. Further, the circulation passageways 480 are channels that extend through the base section 212. However, the passageways 476, 478, 480 can be staggered and positioned in other locations.

Moreover, FIG. 4 illustrates that the upper surface 370 extends above the bearing pads 236. With this design, the magnets 220 are inhibited from contacting the bearing pads 236. The distance in which the upper surface 370 extends above the bearing pads 236 can be varied. For example, the upper surface 370 can extend between approximately 0.1 microns and 2 microns above the bearing pads 236. However greater or smaller distances can be utilized.

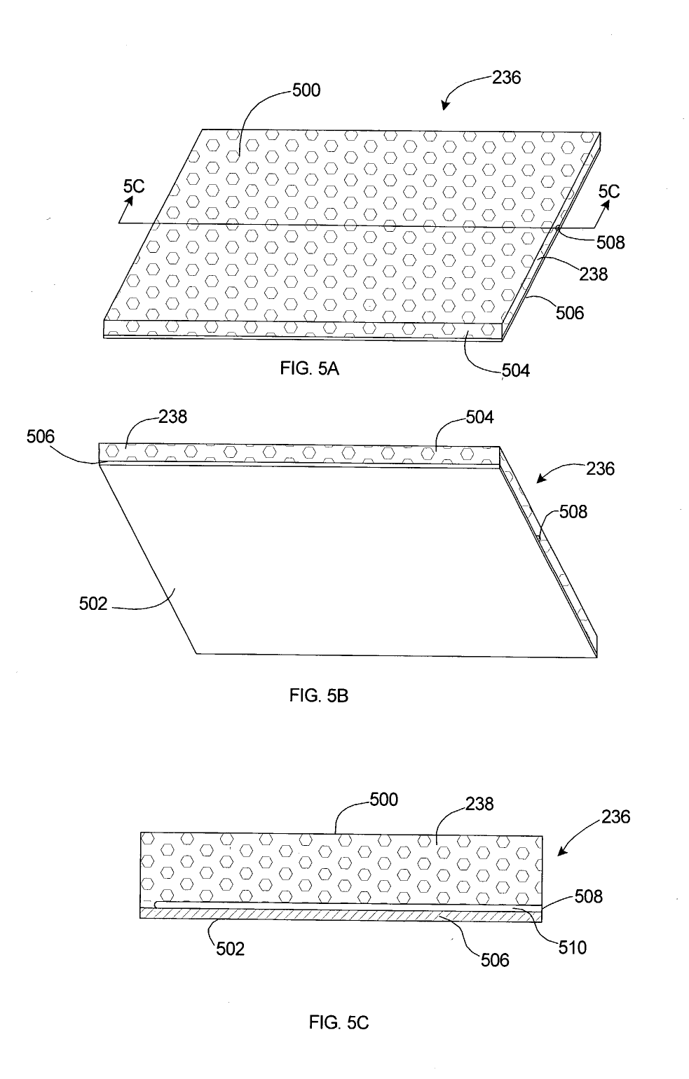

FIGS. 5A and 5B illustrate alternate perspective views of a bearing pad 236 having features of the present invention. In this embodiment, the bearing pad 236 is generally rectangular plate shaped and includes a top, bearing surface 500, an opposed, bottom non-bearing surface 502 and four side surfaces 504. The bearing pad 236 can have a pad thickness of between 10-400 microns. However, other shapes and thicknesses are possible.

Further, the bearing pad 236 includes the porous region 238 that defines the bearing surface 500, and a sealed, non-porous region 506 that defines the non-bearing surface 502 that is secured to the porous region 238. Further, at least one of the side surfaces 504 includes a pad inlet 508. The pad inlet 508 is in fluid communication with one of the bearing passageways 478 (illustrated in FIG. 4) and the bearing fluid source 234 (illustrated in FIG. 4). This allows for the transfer of fluid from the bearing fluid source 234 to the bearing pad 236. Alternatively, for example, the pad inlet 508 can extend through the non-bearing surface 502.

The porous region 238 allows for the flow of fluid therethrough. The design of the porous region 238 can be varied. For example, the porous region 238 can include a plurality of relatively small pores that form a dense system of interconnected cavities that allow for the flow of the fluid therethrough. For example, the porous region 238 can include a plurality of pores that are between approximately 10-300 microns. In one embodiment, the porous region 238 includes pores that are between approximately 50-100 microns. In alternative embodiments, the porous region 238 includes pores that are between approximately 100-150 microns, 150-200 microns, 200-250 microns, or 250-300 microns. Additionally, the size of the pores can vary along the porous region 238.

Because the pores are micron-sized, the thickness of the bearing pad 236 can be made relatively thin while simultaneously assuring a substantial bearing force. The porous region 238 can be made of a low or non-electrically conductive, non-magnetic material, such as low electrical conductivity stainless steel or titanium, or non-electrically conductive plastic or ceramic.

The non-porous region 506 is substantially impermeable to the flow of the fluid therethrough. Suitable materials for the non-porous region 506 include a low or non-electrically conductive, non-magnetic material, such as low electrical conductivity stainless steel or titanium, or non-electrically conductive plastic or ceramic.

The porous region 238 can be secured to the non-porous region 506 in a number of ways. For example, an adhesive can be used to secure the porous region 238 to the non-porous region 506.

FIG. 5C is cutaway view taken on line 5C in FIG. 5A. FIG. 5C illustrates that the bearing pad 236 includes a pad fluid channel 510 positioned between the bearing surface 500 and the non-bearing surface 502. The pad fluid channel 510 is connected to the pad inlet 508 and facilitates the uniform distribution of the fluid throughout the bearing pad 236. This facilitates a better fluid film bearing and a more efficient stage assembly 10. The location of the pad fluid channel 510 can be varied. For example, the pad fluid channel 510 can be positioned in the porous region 238 and/or in the non-porous region 506. In FIG. 5C, the pad fluid channel 510 is positioned in the porous region 238. Alternatively, the pad fluid channel 510 can be positioned in the non-porous region 506 or in both regions 238, 506.

FIG. 5D is an exploded perspective view of the bearing pad 236 of FIG. 5A. FIG. 5D illustrates that the bearing pad 236 includes the substantially rectangular shaped porous region 238 and the substantially rectangular shaped non-porous region 506. FIG. 5D also illustrates the pad fluid channel 510 in more detail.

The design of the pad fluid channel 510 can be varied. In FIG. 5D the pad fluid channel 510 includes a first pad passageway 512 and a plurality of second pad passageways 514 that branch away from the first pad passageway 512. In this embodiment, a cross-sectional area of the first pad passageway 512 is larger than a cross-sectional area of one of the second pad passageways 514. Further, in this embodiment, each passageway 512, 514 has a substantially uniform cross-section along the respective passageway 512, 514. Alternatively, one or both passageways 512, 514 could be tapered and/or have a non-uniform cross-section.

It should be noted that other geometries of the pad passageways 512, 514 can be utilized. For example, the pad fluid channel 510 could include a plurality of first pad passageways 512, each having a number of second pad passageways 514. Further, one or more of the pad passageways 512, 514 can be positioned in the non-porous region 506.

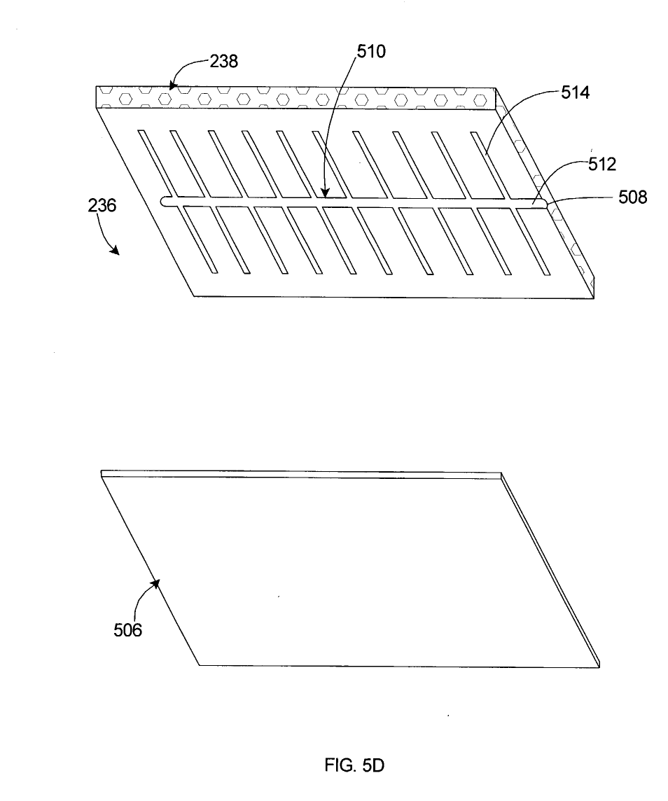

As provided herein, various high-strength structures can be intermeshed in a suitable way in the bearing pad 636. FIG. 6 illustrates a cut-away view of another embodiment of a bearing pad 636 having features of the present invention. In this embodiment, the bearing pad 636 includes a porous region 638 and a non-porous region 606. Further, in this embodiment, the bearing pad 636 includes one or more pad supports 650 that are integrated into the bearing pad 636 to improve the flexural strengths of the bearing pad 636. For example, each pad support 650 can be a beam that is intermeshed into the bearing pad 636. The beams can be made of a rigid, non-magnetic material such as a ceramic material.

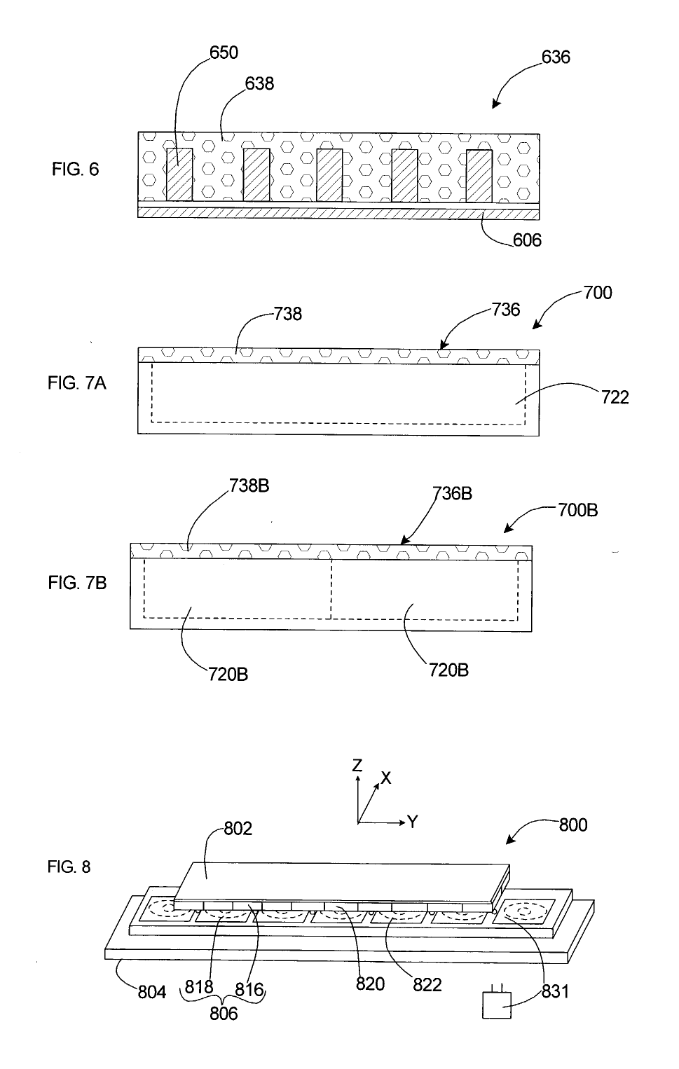

FIG. 7A illustrates a mover pad 700 having features of the present invention. In this embodiment, a bearing pad 736 is integrated directly into a conductor 722 to form the mover pad 700. Stated another way, in one embodiment, a mover pad 700 is formed by combining a bearing pad 736 directly with a conductor 722. More specifically, the surface layer of the conductor 722 to a significant depth, includes a porous region 738 that defines the bearing pad 736. For example, the surface layer of the conductor 722 to a depth of between approximately 50 microns and 200 microns can have a plurality of pores that are between approximately 10 microns and 200 microns. Further, the conductor 722 can include a coil that is made of conventional insulated wire bonded together or potted in an epoxy.

With this design, the bearing fluid source 234 (illustrated in FIG. 2) releases the fluid into the mover pad 700 to create the fluid film bearing that supports the stage frame 202 (illustrated in FIG. 2). The mover pad 700 can be made by etching the top of the conductor 722 or by other mechanical means.

Alternatively, a porous material could be rigidly secured to the top of the conductor 722 to form the mover pad 700.

FIG. 7B illustrates another embodiment of a mover pad 700B having features of the present invention. In this embodiment, a bearing pad 736B is integrated directly into a pair of magnets 720B to form the mover pad 700B. More specifically, the surface layer of the magnet 720B to a significant depth includes a porous region 738B that defines the bearing pad 736B. For example, the surface layer of the magnet 720B to a depth of between approximately 10 microns and 100 microns can include a plurality of pores that are between approximately 20 microns and 100 microns. The magnet 720B can be made of NdBFe or some other magnetic material.

With this design, the bearing fluid source 234 releases the fluid into the mover pad 700B to create the fluid film bearing that supports the stage frame 202. The mover pad 700B can be made by etching or other mechanical means the top of the magnet 720B. Alternatively, a porous material could be rigidly secured to the top of the magnet 720B to form the mover pad 700B.

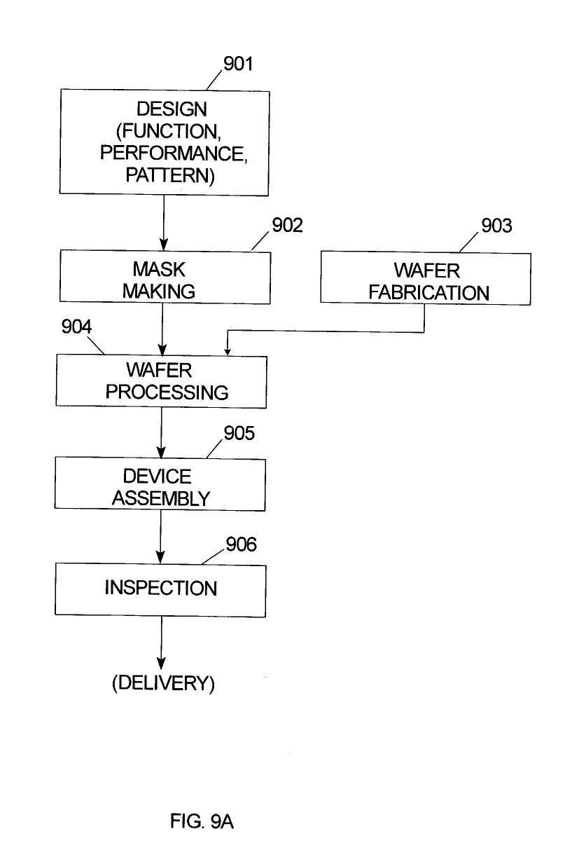

The present invention can be used with other types of motors and other stage assemblies. For example, FIG. 8 is a perspective view of another embodiment of a stage assembly 800 that can be used in the exposure apparatus 10 (illustrated in FIG. 1). In FIG. 8, the stage assembly 800 includes a stage frame 802, a base frame 804, a mover 806, and a combination 831 that creates a fluid film bearing that allows for movement of the stage frame 802 relative to the base frame 804.

In FIG. 8, the stage frame 802, the base frame 804, and the combination 831 that creates the fluid film bearing are somewhat similar to the corresponding components described above and illustrated in FIG. 2. However, in this embodiment, mover 806 is a linear motor that is movable along only one axis, e.g. the Y axis. In this embodiment, the mover 806 includes the magnet assembly 816 again spaced apart from the conductor assembly 818 with the fluid film bearing. However, in this embodiment, the magnet assembly 816 includes a single row of magnets 820 arranged in a linear pattern and the conductor assembly 818 includes a single row of conductors 822 arranged in a linear pattern.

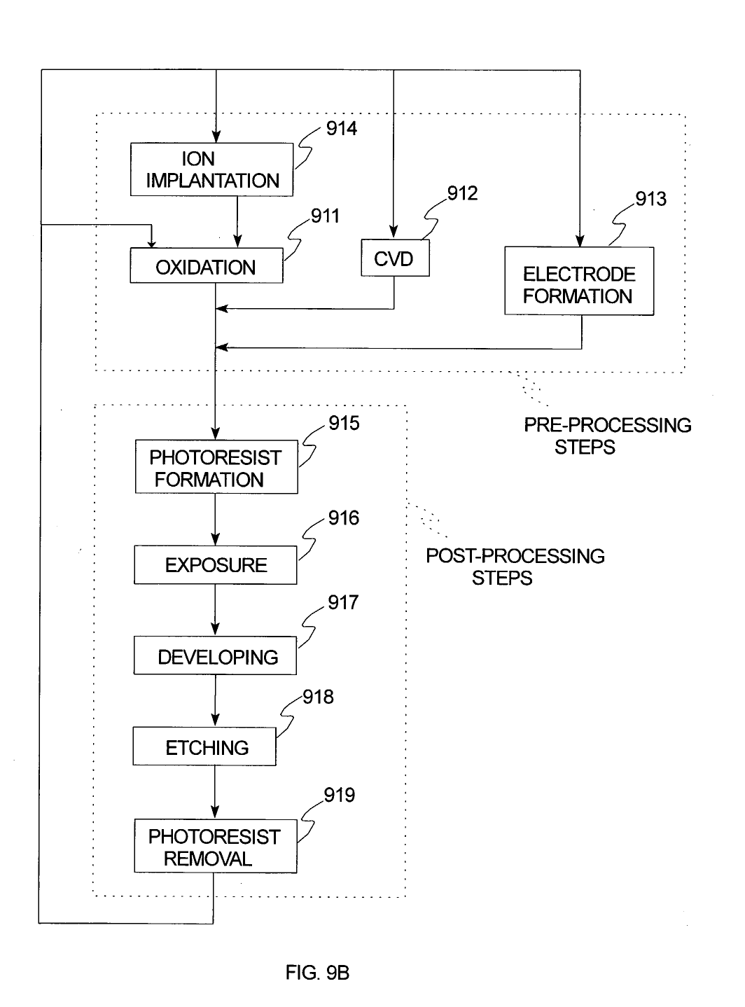

Semiconductor devices can be fabricated using the above described systems, by the process shown generally in FIG. 9A. In step 901 the device's function and performance characteristics are designed. Next, in step 902, a mask (reticle) having a pattern is designed according to the previous designing step, and in a parallel step 903 a wafer is made from a silicon material. The mask pattern designed in step 902 is exposed onto the wafer from step 903 in step 904 by a photolithography system described hereinabove in accordance with the present invention. In step 905 the semiconductor device is assembled (including the dicing process, bonding process and packaging process), finally, the device is then inspected in step 906.

FIG. 9B illustrates a detailed flowchart example of the above-mentioned step 904 in the case of fabricating semiconductor devices. In FIG. 9B, in step 911 (oxidation step), the wafer surface is oxidized. In step 912 (CVD step), an insulation film is formed on the wafer surface. In step 913 (electrode formation step), electrodes are formed on the wafer by vapor deposition. In step 914 (ion implantation step), ions are implanted in the wafer. The above mentioned steps 911-914 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 915 (photoresist formation step), photoresist is applied to a wafer. Next, in step 916 (exposure step), the above-mentioned exposure device is used to transfer the circuit pattern of a mask (reticle) to a wafer. Then in step 917 (developing step), the exposed wafer is developed, and in step 918 (etching step), parts other than residual photoresist (exposed material surface) are removed by etching. In step 919 (photoresist removal step), unnecessary photoresist remaining after etching is removed.

Multiple circuit patterns are formed by repetition of these preprocessing and post-processing steps.

While the particular precision assembly as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A combination that creates a fluid bearing that maintains a stage frame spaced apart from a base frame, the combination comprising:
a pad assembly secured to one of the frames, the pad assembly including a porous region; and
a bearing fluid source that directs a fluid into the pad assembly so that the fluid is released from the porous region to create the fluid bearing that maintains at least a portion of the stage frame apart from the base frame.

2. The combination of claim 1 wherein the pad assembly includes a pad fluid channel that is in fluid communication with the bearing fluid source and the porous region.

3. The combination of claim 2 wherein the pad fluid channel includes a first pad passageway and a second pad passageway that branches away from the first pad passageway.

4. The combination of claim 3 wherein the pad fluid channel includes a plurality of second pad passageways, and a cross-sectional area of the first pad passageway is larger than a cross-sectional area of one of the second pad passageways.

5. The combination of claim 1 wherein the porous region includes a plurality of pores that are between approximately 10 microns and 300 microns.

6. The combination of claim 1 wherein the porous region includes a plurality of pores that are between approximately 100 microns and 200 microns.

7. The combination of claim 1 wherein the pad assembly includes a plurality of spaced apart porous regions.

8. A mover assembly including a magnet assembly, a conductor assembly, and the combination of claim 1.

9. The mover assembly of claim 8 wherein the pad assembly is positioned directly between the magnet assembly and the conductor assembly.

10. The mover assembly of claim 8 wherein the magnet assembly is secured to one of the frames and the conductor assembly is secured to the other frame.

11. The mover assembly of claim 10 wherein the conductor assembly is secured directly to the pad assembly.

12. The mover assembly of claim 10 wherein the magnet assembly is secured directly to the pad assembly.

13. A stage assembly including a stage frame, a base frame and the mover assembly of claim 8.

14. The stage assembly of claim 13 wherein the base frame includes a bearing passageway that is in fluid communication with the bearing fluid source and the porous region.

15. The stage assembly of claim 13 wherein the base frame includes a vacuum passageway that is fluid communication with a vacuum source to create a vacuum between the frames.

16. The stage assembly of claim 13 wherein the base frame includes an upper surface that extends closer to the stage frame than the pad assembly.

17. An exposure apparatus including the stage assembly of claim 13 and an illumination system.

18. A wafer on which an image has been formed by the exposure apparatus of claim 17.

19. A device on which an image has been formed by the exposure apparatus of claim 17.

20. A stage assembly for moving a device relative to a mounting base, the stage assembly comprising:
a stage frame that retains the device;
a base frame that is secured to the mounting base; and
a mover combination that moves the stage frame relative to the base frame and supports the stage frame away from the base frame, the mover combination including a magnet assembly that is secured to one of the frames, a conductor assembly that is secured to the other frame, and a bearing fluid source; wherein one of the assemblies of the mover combination includes a porous region and the bearing fluid source directs a fluid into the porous region so that the fluid is released from the porous region to create the fluid bearing that maintains at least a portion of the stage frame apart from the base frame.

21. The stage assembly of claim 20 wherein the porous region is positioned adjacent to the magnet assembly.

22. The stage assembly of claim 20 wherein the magnet assembly is secured to the stage frame and the conductor assembly is secured to the base frame.

23. The stage assembly of claim 20 wherein the porous region is integrated directly into the conductor assembly.

24. The stage assembly of claim 20 wherein the porous region is integrated directly into the magnet assembly.

25. The stage assembly of claim 20 wherein the porous region includes a first pad passageway and a second pad passageway that branches away from the first pad passageway.

26. The stage assembly of claim 20 wherein the porous region includes a plurality of pores that are between approximately 10 microns and 300 microns.

27. The stage assembly of claim 20 wherein the porous region includes a plurality of pores that are between approximately 100 microns and 200 microns.

28. The stage assembly of claim 20 wherein the base frame includes a vacuum passageway that is fluid communication with a vacuum source to create a vacuum between the frames.

29. An exposure apparatus including the stage assembly of claim 20 and an illumination system.

30. A wafer on which an image has been formed by the exposure apparatus of claim 29.

31. A device on which an image has been formed by the exposure apparatus of claim 29.

32. A method for maintaining a stage frame spaced apart from a base frame, the method comprising the steps of:
securing a pad assembly to one of the frames, the pad assembly including a porous region; and
directing a fluid from a bearing fluid source into the pad assembly so that the fluid is released from the porous region to create the fluid bearing that maintains at least a portion of the stage frame apart from the base frame.

33. The method of claim 32 wherein the step of directing a fluid includes the step of directing fluid into a pad fluid channel of the pad assembly that is in fluid communication with the bearing fluid source.

34. The method of claim 32 wherein the pad fluid channel includes a first pad passageway and a second pad passageway that branches away from the first pad passageway.

35. The method of claim 34 wherein the pad fluid channel includes a plurality of second pad passageways, and a cross-sectional area of the first pad passageway is larger than a cross-sectional area of one of the second pad passageways.

36. The method of claim 32 wherein the porous region includes a plurality of pores that are between approximately 10 microns and 300 microns.

37. The method of claim 32 wherein the porous region includes a plurality of pores that are between approximately 100 microns and 200 microns.

38. A method for manufacturing a stage assembly that moves a device, the method comprising the steps providing a stage frame that retains the device, providing a base frame, and maintaining the stage frame spaced apart from the base frame by the method of claim 32.

39. The method of claim 38 further comprising the step of moving the stage frame relative to the base frame with a mover.

40. The method of claim 39 wherein the step of moving includes the steps of securing a magnet assembly to one of the frames and securing a conductor assembly to the other one of the frames.

41. The method of claim 40 further comprising the step of creating a vacuum between the frames.

42. A method of making an exposure apparatus that forms an image formed on a first object on a second object, the method comprising the steps of:
securing one of the objects to the stage assembly made by the method of claim 38; and
providing an irradiation apparatus that irradiates the first object.

43. A method of making a device utilizing the exposure apparatus made by the method of claim 42.

44. A method for making a wafer utilizing the exposure apparatus made by the method of claim 42.
